(19) United States
(12) Patent Application Publication
(10) Pub. No.: US 2026/0361652 A1
(43) Pub. Date: Nov. 12, 2026

(54) PROACTIVE L4S ADAPTATION METHOD IN ANTICIPATION OF DEGRADED WIRELESS EXPERIENCE

(71) Applicant: Cisco Technology, Inc., San Jose, CA (US)

(72) Inventors: Binita Gupta, San Diego, CA (US); Robert Edgar Barton, Richmond (CA); Jerome Henry, Pittsboro, NC (US); Juan Carlos Zuniga, Montreal (CA)

(21) Appl. No.: 19/639,666

(22) Filed: Apr. 6, 2026

Related U.S. Application Data
(60) Provisional application No. 63/800,496, filed on May 6, 2025.

(51) Int. Cl. H04L 47/127; H04L 41/16; H04L 47/25; H04W 24/08; H04W 28/02; H04W 84/12

(52) U.S. Cl. CPC H04L 47/127; H04L 41/16; H04L 47/25; H04W 24/08; H04W 28/0236; H04W 84/12

(57) ABSTRACT

In one embodiment, an access point in a wireless network performs a method comprising: engaging in wireless communication with a station in which the station is in a Low Latency, Low Loss, Scalable Throughput (L4S) flow with a remote application, the remote application serving as a sender of a data stream associated with the L4S flow and the station serving as a receiver of the data stream, or vice versa; predicting that the station will experience an event that will result in a degraded wireless experience at the station; and based on the predicting, applying to packets in the data stream, an L4S Congestion Experienced (CE) marking so as to cause the sender to reduce a data rate for the data stream to account for a predicted degraded wireless experience expected at the station.

### CROSS-REFERENCE TO RELATED APPLICATION

This application claims priority to U.S. Provisional Patent Application No. 63/800,496, filed May 6, 2025, entitled “Proactive L4S Adaptation Method While Roaming,” the entirety of which is incorporated herein by reference.

### TECHNICAL FIELD

The present disclosure relates to wireless network equipment and services.

### BACKGROUND

Networking architectures have grown increasingly complex in communications environments, particularly wireless networking environments. For wireless local area networks (WLANs), Institute of Electrical and Electronics Engineers (IEEE) 802.11 specifications are working towards the definition of Low Latency, Low Loss, Scalable Throughput (L4S) mechanisms for implementation via WLAN access points (APs) and client devices or stations (STAs). Thus, there are new challenges and opportunities with regard to L4S solutions that can be provided for WLAN APs and STAs.

### BRIEF DESCRIPTION OF THE DRAWINGS

FIG. 1 is a diagram of a wireless local area network (WLAN) that includes stations and access points that support Low Latency, Low Loss, Scalable Throughput (L4S) mechanisms, and in which L4S is leveraged to manage handling of L4S for predicted events that result in degraded wireless performance/experience at a station, according to an example embodiment.

FIG. 2 illustrates a block diagram of components of a device configured to perform functions associated with operations discussed in connection with embodiments herein.

FIG. 3 is a flow diagram illustrating an example method for proactively (predictively) adapting a data rate using L4S mechanisms prior to an expected wireless performance degradation, in accordance with embodiments of the present disclosure.

FIG. 4 is a block diagram illustrating an alternate embodiment in which a station initiates proactive adaptation of a data rate based on a predicted wireless performance degradation event, in accordance with embodiments of the present disclosure.

FIG. 5 is a diagram illustrating an example packet stream in which L4S Congestion Experienced (CE) marking is selectively applied to a subset of packets, in accordance with embodiments of the present disclosure.

FIG. 6 illustrates a high-level flow chart depicting a method performed by an access point according to example embodiments presented herein.

FIG. 7 illustrates a flow chart depicting a method performed by a station according to the techniques presented herein.

FIG. 8 illustrates a hardware block diagram of an apparatus or device that may perform functions associated with operations discussed herein in connection with the techniques described for embodiments herein.

### DETAILED DESCRIPTION

### Overview

Embodiments herein provide techniques to leverage the Low Latency, Low Loss, Scalable Throughput (L4S) mechanism to slow the bitrate just before a STA roams from one AP to another AP. This allows for protecting the performance of the application being served to that STA during a roam.

In one embodiment, a method is provided that is performed by an access point in a wireless network, comprising: engaging in wireless communication with a station in which the station is in a Low Latency, Low Loss, Scalable Throughput (L4S) flow with a remote application, wherein the remote application serves as a sender of a data stream associated with the L4S flow and the station serves as a receiver of the data stream, or the station serves as a sender of the data stream and the remote application serves as a receiver of the data stream; predicting that the station will experience an event that will result in a degraded wireless experience at the station; and based on the predicting, applying to packets in the data stream, an L4S Congestion Experienced (CE) marking so as to cause the sender to reduce a data rate for the data stream to account for a predicted degraded wireless experience expected at the station.

In another embodiment, a method is provided that is performed by a station in a wireless network, comprising: detecting, at the station, a likelihood of an upcoming event that is expected to result in a degraded wireless experience for the station; based on the detecting, generating, at a media access control (MAC) layer of the station, an indication of the upcoming event; providing the indication of the upcoming event from the MAC layer to at least one upper protocol layer of the station; and in response to the indication: when the station is a sender of a data stream associated with a Low Latency, Low Loss, Scalable Throughput (L4S) flow, locally reducing a data rate of packets transmitted by the station for the data stream; and when the station is a receiver of the data stream associated with an L4S flow, applying L4S Congestion Experienced (CE) marking to packets for the data stream that causes congestion feedback to be generated at a transport layer of the station to induce a remote sender of the data stream to reduce a data rate in accordance with L4S operation, wherein reduction of the data rate occurs prior to occurrence of the upcoming event.

### Example Embodiments

In a wireless local area network (WLAN), such as an IEEE 802.11 (Wi-Fi®) network, one or more wireless APs provide wireless Radio Frequency (RF) coverage over which one or more wireless devices (e.g., phones, wearable devices, tablets, etc.), often referred to as wireless client devices or stations (STAs), can connect to the APs in order to connect to one or more data networks (e.g., the public Internet, an enterprise network operated by an enterprise entity (e.g., a business, institution, university, etc.)), and/or the like.

Low Latency, Low Loss, Scalable Throughput (L4S) is an architecture and protocol suite defined by the Internet Engineering Task Force (IETF), such as through Request for Comments (RFCs) 9330, 9331, and 9332, with the purpose of providing low queuing latency, low packet loss, and scalable throughput control for all manner of real-time applications (e.g., streaming video, multiplayer games, and/or other real-time applications).

L4S is a congestion management technology that significantly improves application performance without dropping packets, but allows networks to interact with applications and hosts to influence the bitrate of data streams when congestion is detected.

L4S works well when the cause of packet loss is congestion. However, L4S is reactive. Congestion occurs first, then is detected by the congested node, which applies the Congestion Experienced (CE) codepoint to an L4S packet forwarded next to a receiver; the receiver signals congestion on its returning packet (typically a Transmission Control Protocol (TCP) Acknowledgment (ACK)) to the sender, then the sender starts reducing its bit rate. The process is an order of magnitude more reactive and granular than traditional TCP methods, but is still reactive.

According to an embodiment, an access point engages in wireless communication with a station in which the station is in a Low Latency, Low Loss, Scalable Throughput (L4S) flow with a remote application. The remote application or the station serves as a sender of a data stream for the L4S flow. The access point predicts that the station will experience an event that will result in a degraded wireless experience at the station. Based on the predicting, the access point applies to packets in an upstream direction and/or a downstream direction between the station and the remote application, an L4S Congestion Experienced (CE) marking so as to cause the sender, whether the sender is the station or the remote application, to reduce a data rate for the data stream being sent to account for the degraded wireless experience expected at the station.

One case of an event that results in a degraded wireless experience at the station (causing increased packet latency in Wi-Fi® wireless local area networks) is when a station roams from one AP to another. During this time, the performance of a sender-receiver pair will be momentarily inhibited, giving a similar result to congestion. Presented herein are techniques to leverage the L4S mechanism to slow the bitrate just before the event (e.g., a roam) occurs, thereby protecting the application’s performance when the event occurs (e.g., during a roam).

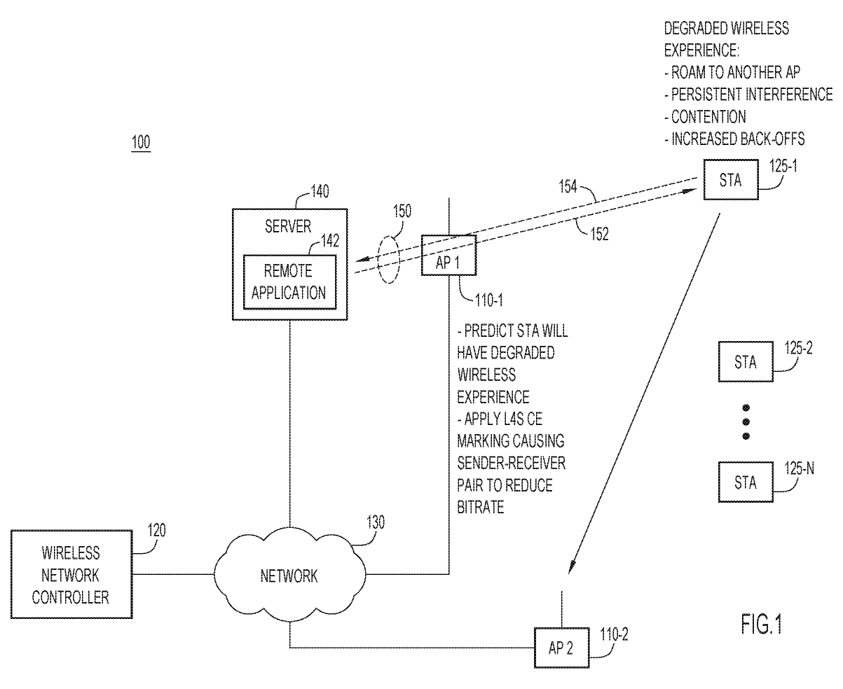

FIG. 1 illustrates a wireless local area network (WLAN) environment 100 that includes APs and stations (STAs) that support L4S. The WLAN environment 100 includes, for example, AP1 at reference numeral 110-1 and AP2 at reference numeral 110-2. There may be numerous more APs in the WLAN environment, but for simplicity, only two APs are shown in FIG. 1. The WLAN environment 100 further includes a wireless network controller, also known as a wireless local area network (WLAN) controller (WLC) 120 that may also play a role in the techniques described below. The APs 110-1 and 110-2 are connected to a network 130 to which the WLC 120 may also be connected. The APs 110-1 and 110-2 serve a plurality of STAs 125-1, 125-2, …, 125-N in the WLAN environment 100. The network 130 may represent one or more local area networks (LANs) and a wide area network (WAN), e.g., the Internet. A server 140 also has connectivity to the network 130, and the server hosts, for example, a remote application 142.

A method is presented to leverage the L4S CE marking mechanism as a way to proactively lower the sender-receiver bitrate just before a roam occurs, and then to set it back to normal after the roam completes. While this takes roaming as an illustrative use case of a network anomaly that leverages the L4S congestion mechanism, these techniques can be applied to other scenarios where an upcoming STA performance degradation can be predicted.

As indicated in FIG. 1, AP 110-1 is serving wireless connectivity for STA 125-1, and there is an L4S flow 150 ongoing between STA 125-1 and the remote application 142 hosted by server 140. AP 110-1 supports the wireless portion of that flow with the STA 125-1. The L4S flow 150 may comprise a data stream from the remote application 142 to the STA 125-1 in what is referred to as a downstream or downlink direction, shown at reference numeral 152, and/or a data stream from the STA 125-1 to the remote application 142 in what is referred to as an upstream or uplink direction shown at reference numeral 154. The AP 110-1 predicts when the STA 125-1 will have a degraded wireless experience, and upon such a prediction, applies L4S Congestion Experienced (CE) marking to packets to cause the sender (the STA 125-1 or the remote application 142) to reduce a data rate for the data stream being sent to account for the predicted degraded wireless experience at the STA 125-1. Furthermore, as shown in FIG. 1, the degraded wireless experience may be associated with one or more of: the STA 125-1 roaming to another AP, e.g., to AP 110-2; persistent interference at the STA 125-1 such as from a nearby AP, e.g., AP 110-2; contention by the STA 125-1 on a channel used by the AP 110-1 due to a large number of STAs connected to the AP 110-1; and increased back-offs for transmissions to be made by the STA 125-1.

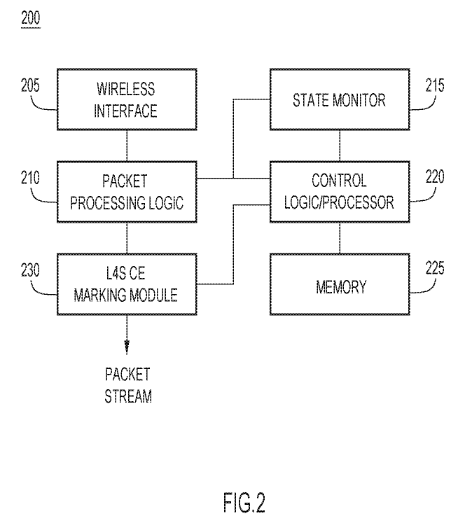

FIG. 2 is a block diagram illustrating example functional components of a device 200 configured to perform proactive Low Latency, Low Loss, Scalable Throughput (L4S) congestion adaptation in accordance with embodiments of the present disclosure. In some embodiments, the device 200 may comprise an access point (e.g., one of the APs shown in FIG. 1), a wireless network controller (e.g., the WLC shown in FIG. 1), or a combination thereof.

As shown in FIG. 2, the device 200 includes a wireless interface 205 configured to communicate with one or more stations over a wireless medium. The wireless interface 205 may comprise one or more radio transceivers and one or more modems, for example. Packet processing logic 210 is provided that is coupled to the wireless interface 205 and which processes packets received or transmitted by the wireless interface 205, which may include forwarding, classification, and queue management functionality.

The device 200 further includes a state monitor 215 configured to observe one or more wireless performance parameters associated with a station. Such parameters may include, by way of example and not limitation, received signal strength indication (RSSI) information, throughput, forwarding delay, buffer depth, retransmission behavior, contention levels, or other indicators of wireless performance or impending performance degradation. The observed parameters may be collectively referred to as metrics. The state monitor 215 generates these metrics from data obtained from the packet processing logic 210.

The device 200 further includes a control logic/processor 220, a memory 225, and a L4S CE marking module 230. The control logic/processor 220 is coupled to the packet processing logic 210

The state monitor 215 provides the observed metrics to the control logic/processor 220, which may execute instructions stored in memory 225 to analyze the metrics and determine whether a station is likely to experience a degradation in wireless performance. In some embodiments, this determination may be based on a predictive process, including but not limited to machine-learning or artificial-intelligence techniques.

Based on the analysis performed by the control logic/processor 220, the L4S Congestion Experienced (CE) marking module 230 selectively applies L4S CE marking to packets associated with a data stream exchanged between the station and a remote application. The CE marking may be applied to packets in a downstream direction, an upstream direction, or both, and may be applied to a subset of packets or at a controllable frequency. The resulting marked packets form a packet stream (data stream) that carries congestion signaling to cause a sender of the data stream to reduce a data rate of the packet stream (data stream) in accordance with L4S operation.

In this manner, the device 200 is configured to proactively apply L4S CE marking in anticipation of a predicted wireless performance degradation event, such as a roaming event, interference condition, or increased contention, rather than waiting for congestion to be detected through conventional queue buildup.

The packet processing logic 210, state monitor 215, and L4S CE marking module 230 may be implemented in one or more integrated circuits or by instructions executed by one or more processors, including the control logic/processor 220.

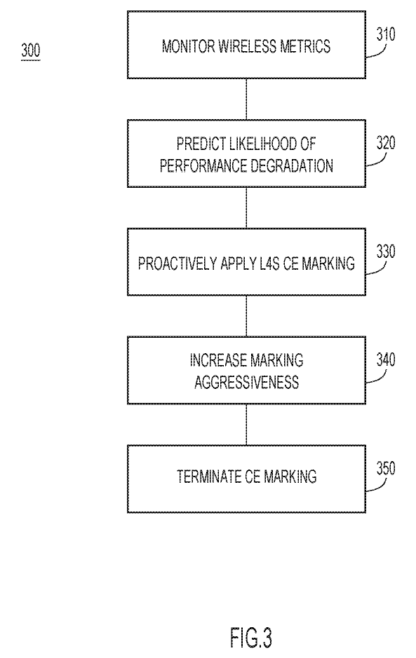

Reference is now made to FIG. 3. FIG. 3 is a flow diagram illustrating an example method 300 for proactively adapting a data rate using Low Latency, Low Loss, Scalable Throughput (L4S) mechanisms prior to an expected wireless performance degradation, in accordance with embodiments of the present disclosure. This method may be performed by an AP that is serving a station or by a WLC, or a combination thereof.

Although not shown, the method 300 pre-supposes that a station has started an L4S flow with a remote application, in which either the station or the remote application (or both) is a sender of a data stream/packet stream to the other.

As shown in FIG. 3, the method 300 includes, at step 310, monitoring wireless metrics associated with a station. Such metrics may include, by way of example and not limitation, received signal strength, throughput, forwarding delay, buffer depth, retransmission behavior, or contention indicators.

Based on the monitored metrics, at step 320, the method 300 further includes predicting a likelihood of a wireless performance degradation event. The event may include, for example, a roaming event, persistent interference, increased contention, or another condition that is expected to degrade communication performance. In some embodiments, the prediction may be generated using statistical analysis, heuristics, or machine-learning or artificial-intelligence techniques.

In step 310, a process on the AP or controller observes the L4S traffic. In one embodiment, the process is a short-term learning machine/predictor (such as Long Short-Term Memory (LSTM) model or Gated Recurrent Unit (GRU) model, but other forms are possible). As the STA moves, the predictor examines the likelihood of an event occurring that will result in degradation of wireless performance. For example, the event is the STA reaching the edge of the cell (coverage area of the AP), and over time can predict with a high margin of certainty if a STA will roam. When a STA roams, packet loss may occur during the roam. The predictor may also measure the increase in forwarding delay to that STA. The predictor may also take as input various other parameters, such as throughput, buffer depth, etc. All of these are inputs that may be used to train the LSTM model to predict a set of likely conditions indicative of an event of degraded wireless experience (performance), such as a roam.

The predictor (e.g., LSTM model) provides this prediction and its associated confidence index to a process on the AP or WLC controller which will result in marking L4S ECN codepoints in either or both upstream and downstream directions. In other words, as the predictor determines that the probability of a roam is increasing, the Explicit Congestion Notification (ECN) codepoints begin to be marked, allowing the sender-receiver pair to slowly lower their bitrate, preserving the user’s application experience.

Thus, when the predicted likelihood satisfies one or more criteria, the method 300 includes at step 330, proactively applying L4S Congestion Experienced (CE) marking to packets associated with a data stream exchanged between the station and a remote application. The CE marking is applied prior to detection of congestion resulting from the event and prior to occurrence of the event itself.

As the likelihood of the predicted event increases, the method 300 may further include, at step 340, increasing the aggressiveness of the CE marking, for example by increasing a frequency of marking or increasing a proportion of packets marked. This causes a sender of the data stream to progressively reduce a data rate in accordance with L4S operation, thereby mitigating the impact of the expected performance degradation. For example, in the case where the event is a roam, the AP continues to monitor the state of the STA and it modifies the prediction of a probability of a roam. As the STA gets closer and closer to the edge of the cell, the probability of the roam increases. As the probability increases, the AP applies the L4S CE markings more aggressively, causing the STA-to-remote application communication to progressively throttle down its bit rate.

After the performance degradation event has occurred or is determined to no longer be likely, at step 350, the method 300 includes terminating the proactive CE marking, allowing normal L4S congestion control behavior to resume.

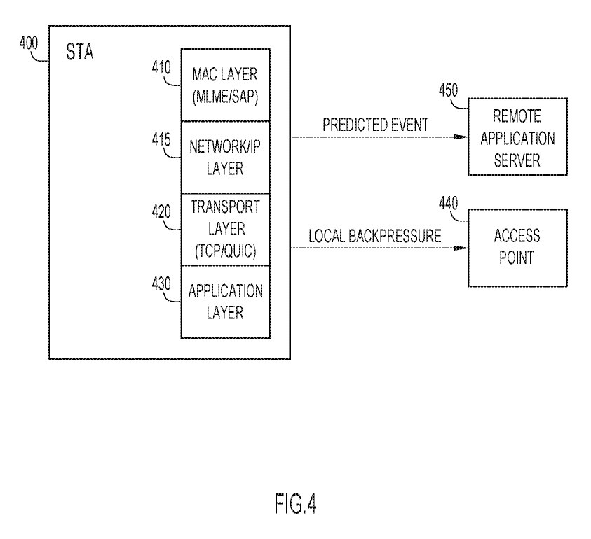

FIG. 4 is a block diagram illustrating an alternate embodiment in which a station 400 initiates proactive adaptation of a data rate based on a predicted wireless performance degradation event, in accordance with embodiments of the present disclosure.

As shown in FIG. 4, a station 400 includes multiple protocol layers, including a media access control (MAC) layer 410, a network/Internet Protocol (IP) layer 415, a transport layer 420, and an application layer 430. L4S CE marking is performed at the network/IP layer 415. The MAC layer 410 may include a MAC Layer Management Entity (MLME) or a MAC Service Access Point (SAP) configured to detect or receive indications of an upcoming event that is expected to degrade wireless performance, such as an imminent roaming event. The transport layer 420 may operate according to Transmission Control Protocol (TCP), Quick Universal Datagram Protocol (UDP) Internet Connections (QUIC), or a similar transport protocol, for example.

Upon detecting or predicting the event, the MAC layer 410 provides an indication of the predicted event to upper layers of the STA 400, that is, to the transport layer 420 and/or application layer 430. In some embodiments, this indication causes the transport layer 420 to apply (at the access point 440 to which the STA 400 is associated) local backpressure to one or more data streams. The local backpressure causes a reduction in a data rate of packets transmitted by the station without waiting for round-trip congestion feedback from a remote receiver.

In embodiments in which the station 400 is a receiver of a data stream from a remote application server 450, the predicted event indication may further result in congestion signaling being generated at the transport layer 420 of the STA 400, such that the remote application server 450 reduces a data rate of packets sent toward the STA in accordance with L4S congestion control behavior. Packets exchanged between the STA 400 and the remote application server 450 are transmitted via the access point 440, as shown.

FIG. 4 thus illustrates that proactive data rate adaptation may be initiated by the station itself, based on local awareness of an upcoming wireless performance degradation event, either by locally reducing a transmit rate when the station is a sender or by triggering congestion feedback when the station is a receiver. This embodiment operates independently of access-point-initiated prediction or marking, although such embodiments may be used in combination.

In the alternative embodiment depicted in FIG. 4, as one example, the STA 400 monitors that it is about to roam. The STA sends a MLME or a MAC SAP indication to the upper layer that roaming can happen soon and requests the following actions:
1) Apply backpressure to slow down the data rate (in uplink (UL)) for local L4S applications/senders;
2) Mark congestion at Layer 4 (TCP or QUIC layer) as a receiver for corresponding application servers to slow down the downlink (DL) data rate.

As the STA finally gets to the edge of the cell, the STA sends measurements and an indication of the need to handover to the next cell. The AP proactively informs the server (hosting the remote application that the STA is in communication with) while the STA has limited connectivity. As the STA completes its roam and resumes normal communication in the next cell, the AP stops proactively declaring congestion on the L4S packets, and lets the L4S process resume its normal course.

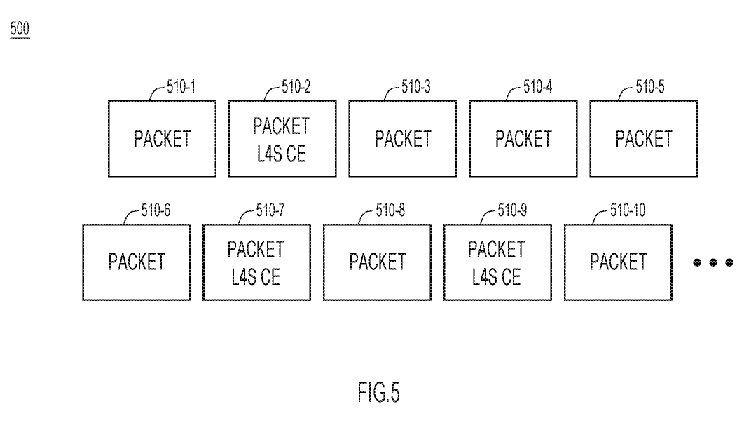

FIG. 5 is a diagram illustrating an example packet stream in which Low Latency, Low Loss, Scalable Throughput (L4S) Congestion Experienced (CE) marking is selectively applied to a subset of packets, in accordance with embodiments of the present disclosure.

As shown in FIG. 5, a packet stream/data stream 500 includes a plurality of packets transmitted between a sender and a receiver. One or more of the packets in the packet stream are marked with an L4S CE codepoint, such as packets 510-2, 510-7, and 510-9, while other packets (510-1, 510-3, 510-4, 510-5, 510-6, 510-8, 510-10) in the packet stream 500 are not marked. The CE-marked packets are visually distinguished in FIG. 5 to indicate that congestion signaling information has been proactively applied to those packets, e.g., packet 510-2.

In some embodiments, the L4S CE marking is applied to selected packets based on a predicted likelihood of a wireless performance degradation event, such as an impending roaming event, interference condition, or increased contention, rather than in response to detected queue buildup. The proportion or frequency of packets marked with the L4S CE codepoint may increase as the predicted likelihood of the event increases. Thus, as between packets 510-6 and 510-10, two packets are marked with L4S CE, an increased frequency compared to between packets 510-1 and 510-5.

The packet stream illustrated in FIG. 5 demonstrates that L4S CE marking need not be applied uniformly to all packets, but may instead be applied in a controlled or progressive manner to influence a data rate of the sender while minimizing disruption to the data stream. The CE-marked packets cause congestion feedback to be generated at a transport layer, resulting in a reduction of the data rate in accordance with L4S congestion control behavior.

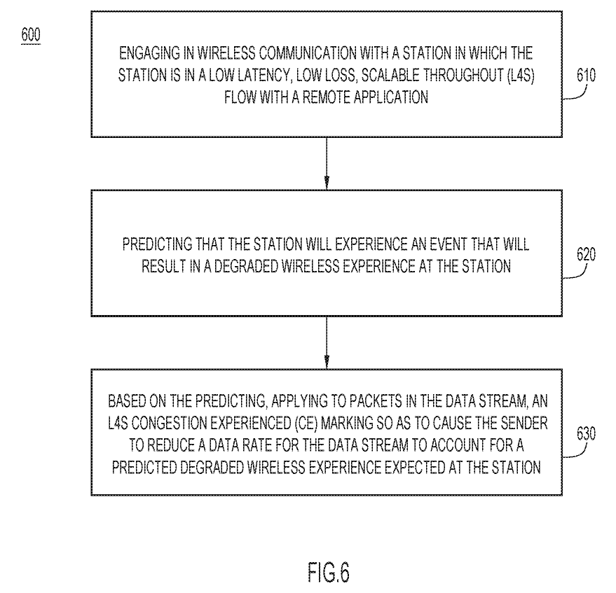

FIG. 6 illustrates a high-level flow chart depicting a method 600 according to example embodiments presented herein. The method 600 is performed by an access point in a wireless network. The method 600 includes, at step 610, engaging in wireless communication with a station in which the station is in a Low Latency, Low Loss, Scalable Throughput (L4S) flow with a remote application. The remote application may serve as a sender of a data stream associated with the L4S flow, and the station serves as a receiver of the data stream, or the station serves as a sender of the data stream and the remote application serves as a receiver of the data stream.

In one example, the prediction in step 610 may involve applying a machine-learning or artificial intelligence process to predict a likelihood of occurrence of the event based on one or more wireless performance parameters measured for the station. In one example, the machine-learning or artificial intelligence process receives as input data related to throughput and/or buffer depth, which are also used to train the machine-learning or artificial intelligence process.

At step 620, the method 600 includes predicting that the station will experience an event that will result in a degraded wireless experience at the station. The predicting may be performed prior to detection of congestion of the data stream between the sender and the receiver that is a result of the degraded wireless experience at the station.

Based on the predicting, at step 630, the method 600 involves applying to packets in the data stream an L4S Congestion Experienced (CE) marking so as to cause the sender to reduce a data rate for the data stream to account for a predicted degraded wireless experience expected at the station. The applying at step 630 is performed prior to occurrence of the event.

The method 600 may further involve terminating applying of the L4S CE marking to packets when the access point detects that the degraded wireless experience at the station has ended.

As explained above, the event may be one or more of: a roaming of the station between access points, a persistent interference experienced at the station, contention in the wireless network due to a large number of stations connected to the access point, and increased back-offs for station transmissions.

In the method 600, the predicting may involve determining that a probability of the event has increased, as a result of which, the applying may involve increasing a frequency or a number of L4S CE markings to packets in the data stream. For example, applying the L4S CE marking may involve marking a subset of packets of the data stream, and increasing a frequency may involve increasing a frequency of L4S CE marking as a predicted probability of the event increases. In one example, the frequency of L4S CE marking increases as the station approaches an edge of a coverage area associated with the access point.

As described in connection with FIG. 5, the method 600 may further involve receiving from the station a message that includes an indication that the event is going to occur, the message including requesting one of: applying backpressure to slow the data rate in an uplink direction for the L4S flow that the station originates and sends to the remote application; and detecting application of L4S CE marking by the station and applying congestion marking at Layer 4 to packets sent by the access point to the remote application to cause the remote application to slow the data rate of the data stream in a downlink direction to the station. In this case, the predicting at step 610 may involve receiving from the station the indication that the event is likely going to occur, the indication being generated by a media access control (MAC) layer management entity (MLME) or a MAC service access point (SAP). Moreover, the reduction of the data rate is performed in response to congestion feedback at a transport layer using the Transmission Control Protocol (TCP), QUIC, or a similar transport protocol.

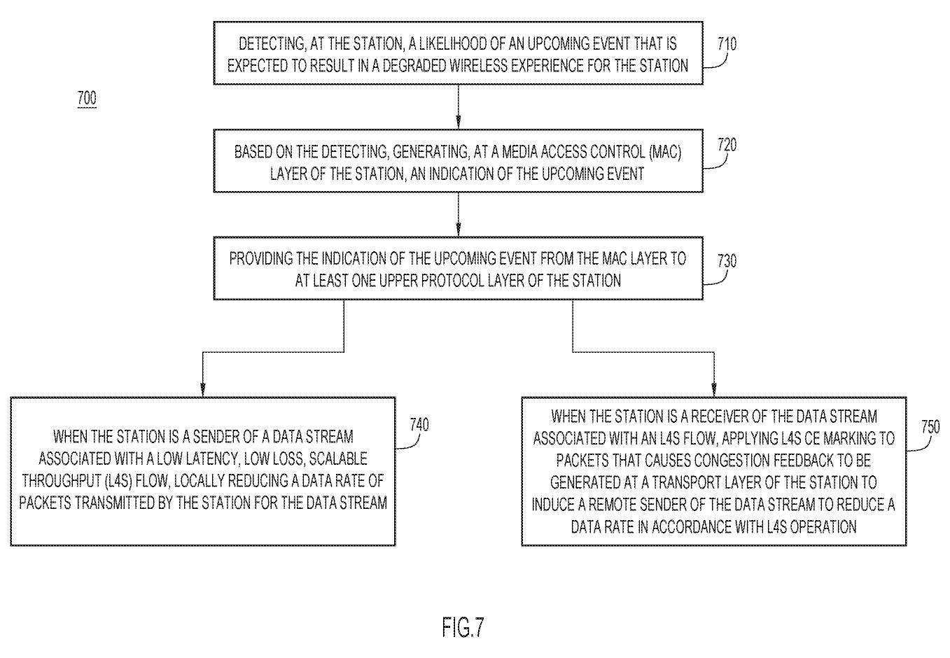

FIG. 7 illustrates a flow chart depicting a method 700 performed by a station according to the techniques presented herein, particularly the techniques described above in connection with FIG. 5. The method 700 comprises, at step 710, detecting, at the station, a likelihood of an upcoming event that is expected to result in a degraded wireless experience for the station. At step 720, based on the detecting step 710, the method 700 involves generating, at a media access control (MAC) layer of the station, an indication of the upcoming event. At step 730, the method 700 involves providing the indication of the upcoming event from the MAC layer to at least one upper protocol layer of the station. As explained above, the upcoming event may comprise one or more of: a roaming event, persistent wireless interference, increased channel contention, or increased retransmissions associated with the station.

In response to the indication, at step 740, when the station is a sender of a data stream associated with a Low Latency, Low Loss, Scalable Throughput (L4S) flow, the method involves locally reducing a data rate of packets transmitted by the station for the data stream. At step 750, when the station is a receiver of the data stream associated with an L4S flow, the method 700 involves applying L4S CE marking to packets for the data stream that causes congestion feedback to be generated at a transport layer of the station to induce a remote sender of the data stream to reduce a data rate in accordance with L4S operation. In the method 700, reduction of the data rate occurs prior to occurrence of the upcoming event.

In the method 700, detecting the likelihood of the upcoming event may involve monitoring one or more wireless performance metrics at the station, including at least one of received signal strength, throughput, retransmission behavior, contention level, or forwarding delay.

In the method 700, generating the indication of the upcoming event may be performed by a media access control (MAC) layer management entity or a MAC service access point of the station.

In the method 700, locally reducing the data rate when the station is the sender may involve applying backpressure at a transport layer of the station without waiting for round‑trip congestion feedback from a remote receiver.

In summary, the techniques involve predicting an event that will result in degraded wireless performance/experience for a station, e.g., a station moving close to the edge of a cell. The AP detects that a STA is about to roam, which will cause momentary performance degradation. In anticipation of this and before that event actually occurs, the AP proactively marks the Explicit Congestion Notification (ECN) = CE codepoint to slow the L4S application before the event occurs (roam happens and) to make the roam (or whatever event occurs) appear more seamless. Once the event ends (e.g., roam completes), the ECN notification goes back to normal. Artificial Intelligence/Machine Learning (AI/ML) prediction techniques may be used in both directions. The STA is caused to also mark congestion when it is about to roam (proactively) using the MLME to inform the upper layer that there is a roam about to happen. Again, this method can be applied to any scenario in which an upcoming STA performance degradation can be predicted.

In various embodiments, prediction of a wireless performance degradation event need not be based on machine-learning or artificial-intelligence techniques. In some embodiments, the prediction may be performed using threshold-based logic, heuristics, statistical analysis, trend detection, or combinations thereof, applied to one or more wireless performance metrics monitored over time. In other embodiments, a hybrid approach may be used in which heuristic or rules-based logic is supplemented by machine-learning outputs to determine a likelihood of the event.

Again, while roaming is described herein as a representative example of an event that may result in a degraded wireless experience, the techniques described are not limited to roaming events. Other events may include, without limitation, persistent or transient interference, changes in channel conditions, increases in channel contention, power-save transitions, scheduling delays, variations in back-off behavior, or network-initiated reconfiguration events. In general, any condition that is predicted to affect latency, throughput, or reliability of wireless communication may serve as a trigger for the proactive techniques described herein.

In various embodiments, application of L4S Congestion Experienced (CE) marking may be performed in different ways. For example, CE marking may be applied periodically, probabilistically, according to a configurable pattern, or based on a confidence level associated with the predicted event. In some embodiments, only a subset of packets in a data stream are marked, while in other embodiments the proportion of packets marked may increase or decrease dynamically over time. The manner in which CE marking is applied may be selected to gradually influence a sender's data rate while minimizing abrupt changes in application behavior.

Although examples herein refer to transport-layer congestion feedback using Transmission Control Protocol (TCP) or QUIC, the techniques described are not limited to any particular transport protocol. In various embodiments, congestion feedback may be communicated using any protocol or mechanism capable of interpreting L4S CE marking or equivalent congestion indications, including future transport protocols or protocol extensions.

In station-initiated embodiments described herein (e.g., in connection with FIGS. 5 and 7), reduction of a data rate may be achieved through different mechanisms depending on implementation. When the station is a sender, the station may apply local backpressure or rate limiting without modifying packet headers. When the station is a receiver, congestion feedback may be generated in response to received CE-marked packets or through other signaling mechanisms at the transport layer. In this manner, proactive data rate adaptation may be performed without requiring modification of encrypted packet payloads or headers.

The functional components and operations described herein may be distributed across one or more network entities. For example, prediction logic may be implemented at an access point, a wireless network controller, a network management system, or a combination thereof. Similarly, CE marking decisions may be coordinated among multiple network elements or performed locally by a single device. The illustrated embodiments are not intended to limit the physical or logical placement of such functionality.

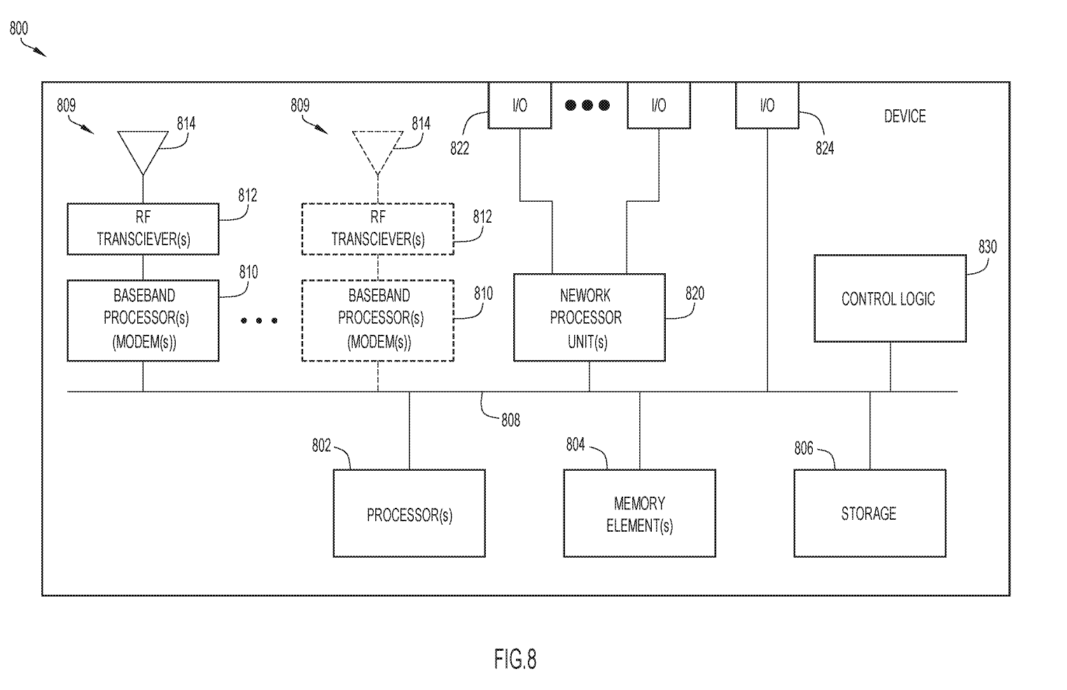

Referring to FIG. 8, FIG. 8 illustrates a hardware block diagram of an apparatus or device 800 that may perform functions associated with operations discussed herein in connection with the techniques described for embodiments herein. Device 800 may be inclusive of any AP and any STA (or WLC) as described for embodiments herein.

In at least one embodiment, the device 800 may be any apparatus that may include one or more processor(s) 802, one or more memory element(s) 820, storage 806, a bus 808, one or more radio modules (also called wireless transceivers) 809, each consisting of a baseband processor (modem) 810, one or more RF transceivers 812, and an antenna 814 (or group of antennas). The device 800 may further include one or more network processor unit(s) 820 interconnected with one or more network input/output (I/O) interface(s) 822, one or more I/O interface(s) 824, and control logic 830. In various embodiments, instructions associated with logic for device 800 can overlap in any manner and are not limited to the specific allocation of instructions and/or operations described herein.

In at least one embodiment, processor(s) 802 are at least one hardware processor configured to execute various tasks, operations, and/or functions for device 800 as described herein according to software and/or instructions configured for device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of the potential processing elements, microprocessors, digital signal processors, baseband signal processors, modems, PHY, controllers, systems, managers, logic, and/or machines described herein can be construed as being encompassed within the broad term 'processor'.

In at least one embodiment, memory element(s) 804 and/or storage 806 are configured to store data, information, software, and/or instructions associated with device 800, and/or logic configured for memory element(s) 804 and/or storage 806. For example, any logic described herein (e.g., control logic 830) can, in various embodiments, be stored for device 800 using any combination of memory element(s) 804 and/or storage 806. Note that in some embodiments, storage 806 can be consolidated with memory element(s) 804 (or vice versa) or can overlap or exist in any other suitable manner.

In at least one embodiment, bus 808 can be configured as an interface that enables one or more elements of device 800 to communicate in order to exchange information and/or data. Bus 808 can be implemented with any architecture designed for passing control, data, and/or information between processors, memory elements, storage, peripheral devices, and/or any other hardware and/or software components that may be configured for device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 820 may enable communication between device 800 and other systems, entities, etc., via network I/O interface(s) 822 (wired and/or wireless) to facilitate operations discussed for various embodiments described herein. In various embodiments, network processor unit(s) 820 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 800 and other systems, entities, etc. to facilitate operations for various embodiments described herein. In various embodiments, network I/O interface(s) 822 can be configured as one or more Ethernet port(s), Fibre Channel ports, any other I/O port(s), and/or antenna(s)/antenna array(s) now known or hereafter developed. Thus, the network processor unit(s) 820 and/or network I/O interface(s) 822 may include suitable interfaces for receiving, transmitting, and/or otherwise communicating data and/or information (wired and/or wirelessly) in a network environment.

I/O interface(s) 824 allow for input and output of data and/or information with other entities that may be connected to device 800. For example, I/O interface(s) 824 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 812 may perform RF transmission and RF reception of wireless signals via antenna(s) 814, and the baseband processor or modem 810 performs baseband modulation and demodulation, etc. associated with such signals to enable wireless communications for device 800.

In various embodiments, control logic 830 can include instructions that, when executed, cause processor(s) 802 to perform operations, which can include, but are not limited to, providing overall control operations of a computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that are capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with the teachings of the present disclosure.

In some instances, software of the present embodiments may be available via a non-transitory computer usable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form, an apparatus as shown and described herein is provided. In one form, a system as shown and described herein is provided. In one form, one or more computer readable storage media encoded with software comprising computer executable instructions are provided herein that, when the software is executed, are operable to perform operations as shown and described herein.

In some aspects, the techniques described herein relate to a method performed by an access point in a wireless network, including: engaging in wireless communication with a station in which the station is in a Low Latency, Low Loss, Scalable Throughput (L4S) flow with a remote application, wherein the remote application serves as a sender of a data stream associated with the L4S flow and the station serves as a receiver of the data stream, or the station serves as a sender of the data stream and the remote application serves as a receiver of the data stream; predicting that the station will experience an event that will result in a degraded wireless experience at the station; and based on the predicting, applying to packets in the data stream, an L4S Congestion Experienced (CE) marking so as to cause the sender to reduce a data rate for the data stream to account for a predicted degraded wireless experience expected at the station.

In some aspects, the techniques described herein relate to a method, wherein predicting is performed prior to detection of congestion of the data stream between the sender and the receiver that is a result of the degraded wireless experience at the station.

In some aspects, the techniques described herein relate to a method, wherein applying is performed prior to occurrence of the event.

In some aspects, the techniques described herein relate to a method, further including terminating applying of the L4S CE marking to packets when the access point detects that the degraded wireless experience at the station has ended.

In some aspects, the techniques described herein relate to a method, wherein the event is one or more of: a roaming of the station between access points, a persistent interference experienced at the station, contention in the wireless network due to a large number of stations connected to the access point, and increased back-offs for station transmissions.

In some aspects, the techniques described herein relate to a method, wherein predicting includes determining that a probability of the event has increased, as a result of which, applying includes increasing a frequency or a number of L4S CE markings to packets in the data stream.

In some aspects, the techniques described herein relate to a method, wherein applying the L4S CE marking includes marking a subset of packets of the data stream, and increasing a frequency of L4S CE marking as a predicted probability of the event increases.

In some aspects, the techniques described herein relate to a method, wherein the frequency of L4S CE marking increases as the station approaches an edge of a coverage area associated with the access point.

In some aspects, the techniques described herein relate to a method, wherein predicting includes applying a machine-learning or artificial intelligence process to predict a likelihood of occurrence of the event based on one or more wireless performance parameters measured for the station.

In some aspects, the techniques described herein relate to a method, wherein the machine-learning or artificial intelligence process receives as input data related to throughput and/or buffer depth, which are also used to train the machine-learning or artificial intelligence process.

In some aspects, the techniques described herein relate to a method, further including: receiving from the station a message that includes an indication that the event is going to occur, the message including requesting one of: applying backpressure to slow the data rate in an uplink direction for the L4S flow that the station originates and sends to the remote application; and detecting application of L4S CE marking by the station and applying congestion marking at Layer 4 to packets sent by the access point to the remote application to cause the remote application to slow the data rate of the data stream in a downlink direction to the station.

In some aspects, the techniques described herein relate to a method, wherein predicting includes receiving from the station the indication that the event is likely going to occur, the indication being generated by a media access control (MAC) layer management entity (MLME) or a MAC service access point (SAP).

In some aspects, the techniques described herein relate to a method, wherein reduction of the data rate is performed in response to congestion feedback at a transport layer using Transmission Control Protocol (TCP), QUIC, or a similar transport protocol.

In some aspects, the techniques described herein relate to a method performed by a station in a wireless network, including: detecting, at the station, a likelihood of an upcoming event that is expected to result in a degraded wireless experience for the station; based on the detecting, generating, at a media access control (MAC) layer of the station, an indication of the upcoming event; providing the indication of the upcoming event from the MAC layer to at least one upper protocol layer of the station; and in response to the indication: when the station is a sender of a data stream associated with a Low Latency, Low Loss, Scalable Throughput (L4S) flow, locally reducing a data rate of packets transmitted by the station for the data stream; and when the station is a receiver of the data stream associated with an L4S flow, applying L4S Congestion Experienced (CE) marking to packets for the data stream that causes congestion feedback to be generated at a transport layer of the station to induce a remote sender of the data stream to reduce a data rate in accordance with L4S operation, wherein reduction of the data rate occurs prior to occurrence of the upcoming event.

In some aspects, the techniques described herein relate to a method, wherein detecting the likelihood of the upcoming event includes monitoring one or more wireless performance metrics at the station, including at least one of received signal strength, throughput, retransmission behavior, contention level, or forwarding delay.

In some aspects, the techniques described herein relate to a method, wherein generating the indication of the upcoming event is performed by a media access control (MAC) layer management entity or a MAC service access point of the station.

In some aspects, the techniques described herein relate to a method, wherein locally reducing the data rate when the station is the sender includes applying backpressure at a transport layer of the station without waiting for round-trip congestion feedback from a remote receiver.

In some aspects, the techniques described herein relate to a method, wherein the upcoming event includes one or more of: a roaming event, persistent wireless interference, increased channel contention, or increased retransmissions associated with the station.

In some aspects, the techniques described herein relate to a wireless access point including: a wireless transceiver configured to transmit and receive wireless signals in a wireless network; a baseband processor configured to perform baseband transmit processing of transmit signals and baseband receive processing of receive signals; and a processor coupled to the baseband processor and to the wireless transceiver, wherein the processor is configured to perform operations including: engaging in wireless communication with a station in which the station is in a Low Latency, Low Loss, Scalable Throughput (L4S) flow with a remote application, wherein the remote application serves as a sender of a data stream associated with the L4S flow and the station serves as a receiver of the data stream, or the station serves as a sender of the data stream and the remote application serves as a receiver of the data stream; predicting that the station will experience an event that will result in a degraded wireless experience at the station; and based on the predicting, applying to packets in the data stream, an L4S Congestion Experienced (CE) marking so as to cause the sender to reduce a data rate for the data stream to account for a predicted degraded wireless experience expected at the station.

In some aspects, the techniques described herein relate to a wireless access point, wherein predicting is performed prior to detection of congestion of the data stream between the sender and the receiver that is a result of the degraded wireless experience at the station, and wherein applying is performed prior to occurrence of the event.

In some aspects, the techniques described herein relate to a wireless station device including: a wireless transceiver configured to transmit and receive wireless signals in a wireless network; a baseband processor configured to perform baseband transmit processing of transmit signals and baseband receive processing of receive signals; and a processor coupled to the baseband processor and to the wireless transceiver, wherein the processor is configured to perform operations including: detecting a likelihood of an upcoming event that is expected to result in a degraded wireless experience for the station; based on the detecting, generating, at a media access control (MAC) layer, an indication of the upcoming event; providing the indication of the upcoming event from the MAC layer to at least one upper protocol layer; and in response to the indication: when the wireless station device is a sender of a data stream associated with a Low Latency, Low Loss, Scalable Throughput (L4S) flow, locally reducing a data rate of packets transmitted by the station for the data stream; and when the wireless station device is a receiver of the data stream associated with an L4S flow, applying L4S Congestion Experienced (CE) marking to packets for the data stream that causes congestion feedback to be generated at a transport layer of the station to induce a remote sender of the data stream to reduce a data rate in accordance with L4S operation, wherein reduction of the data rate occurs prior to occurrence of the upcoming event.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity, and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc., which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores, or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic, or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further, as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained by one skilled in the art and it is intended that the present disclosure encompass all such changes, substitutions, variations, alterations, and/or modifications as falling within the scope of the appended claims.

What is claimed is:

1. A method performed by an access point in a wireless network, comprising:
engaging in wireless communication with a station in which the station is in a Low Latency, Low Loss, Scalable Throughput (L4S) flow with a remote application, wherein the remote application serves as a sender of a data stream associated with the L4S flow and the station serves as a receiver of the data stream, or the station serves as a sender of the data stream and the remote application serves as a receiver of the data stream;
predicting that the station will experience an event that will result in a degraded wireless experience at the station; and
based on the predicting, applying to packets in the data stream, an L4S Congestion Experienced (CE) marking so as to cause the sender to reduce a data rate for the data stream to account for a predicted degraded wireless experience expected at the station.

2. The method of claim 1, wherein predicting is performed prior to detection of congestion of the data stream between the sender and the receiver that is a result of the degraded wireless experience at the station.

3. The method of claim 2, wherein applying is performed prior to occurrence of the event.

4. The method of claim 1, further comprising terminating applying of the L4S CE marking to packets when the access point detects that the degraded wireless experience at the station has ended.

5. The method of claim 1, wherein the event is one or more of: a roaming of the station between access points, a persistent interference experienced at the station, contention in the wireless network due to a large number of stations connected to the access point, and increased back-offs for station transmissions.

6. The method of claim 1, wherein predicting comprises determining that a probability of the event has increased, as a result of which, applying comprises increasing a frequency or a number of L4S CE markings to packets in the data stream.

7. The method of claim 6, wherein applying the L4S CE marking comprises marking a subset of packets of the data stream, and increasing a frequency of L4S CE marking as a predicted probability of the event increases.

8. The method of claim 7, wherein the frequency of L4S CE marking increases as the station approaches an edge of a coverage area associated with the access point.

9. The method of claim 1, wherein predicting comprises applying a machine-learning or artificial intelligence process to predict a likelihood of occurrence of the event based on one or more wireless performance parameters measured for the station.

10. The method of claim 9, wherein the machine-learning or artificial intelligence process receives as input data related to throughput and/or buffer depth, which are also used to train the machine-learning or artificial intelligence process.

11. The method of claim 1, further comprising:
receiving from the station a message that includes an indication that the event is going to occur, the message including requesting one of:
applying backpressure to slow the data rate in an uplink direction for the L4S flow that the station originates and sends to the remote application; and
detecting application of L4S CE marking by the station and applying congestion marking at Layer 4 to packets sent by the access point to the remote application to cause the remote application to slow the data rate of the data stream in a downlink direction to the station.

12. The method of claim 11, wherein predicting comprises receiving from the station the indication that the event is likely going to occur, the indication being generated by a media access control (MAC) layer management entity (MLME) or a MAC service access point (SAP).

13. The method of claim 11, wherein reduction of the data rate is performed in response to congestion feedback at a transport layer using Transmission Control Protocol (TCP) or Quick Universal Datagram Protocol (UDP) Internet Connections (QUIC) protocol.

14. A method performed by a station in a wireless network, comprising:
detecting, at the station, a likelihood of an upcoming event that is expected to result in a degraded wireless experience for the station;
based on the detecting, generating, at a media access control (MAC) layer of the station, an indication of the upcoming event;
providing the indication of the upcoming event from the MAC layer to at least one upper protocol layer of the station; and
in response to the indication:
when the station is a sender of a data stream associated with a Low Latency, Low Loss, Scalable Throughput (L4S) flow, locally reducing a data rate of packets transmitted by the station for the data stream; and
when the station is a receiver of the data stream associated with an L4S flow, applying L4S Congestion Experienced (CE) marking to packets for the data stream that causes congestion feedback to be generated at a transport layer of the station to induce a remote sender of the data stream to reduce a data rate in accordance with L4S operation,
wherein reduction of the data rate occurs prior to occurrence of the upcoming event.

15. The method of claim 14, wherein detecting the likelihood of the upcoming event comprises monitoring one or more wireless performance metrics at the station, including at least one of received signal strength, throughput, retransmission behavior, contention level, or forwarding delay.

16. The method of claim 14, wherein generating the indication of the upcoming event is performed by a media access control (MAC) layer management entity or a MAC service access point of the station.

17. The method of claim 14, wherein locally reducing the data rate when the station is the sender comprises applying backpressure at a transport layer of the station without waiting for round‑trip congestion feedback from a remote receiver.

18. The method of claim 14, wherein the upcoming event comprises one or more of: a roaming event, persistent wireless interference, increased channel contention, or increased retransmissions associated with the station.

19. A wireless access point comprising:
a wireless transceiver configured to transmit and receive wireless signals in a wireless network;
a baseband processor configured to perform baseband transmit processing of transmit signals and baseband receive processing of receive signals; and
a processor coupled to the baseband processor and to the wireless transceiver, wherein the processor is configured to perform operations including:
engaging in wireless communication with a station in which the station is in a Low Latency, Low Loss, Scalable Throughput (L4S) flow with a remote application, wherein the remote application serves as a sender of a data stream associated with the L4S flow and the station serves as a receiver of the data stream, or the station serves as a sender of the data stream and the remote application serves as a receiver of the data stream;
predicting that the station will experience an event that will result in a degraded wireless experience at the station; and
based on the predicting, applying to packets in the data stream, an L4S Congestion Experienced (CE) marking so as to cause the sender to reduce a data rate for the data stream to account for a predicted degraded wireless experience expected at the station.

20. The wireless access point of claim 19, wherein predicting is performed prior to detection of congestion of the data stream between the sender and the receiver that is a result of the degraded wireless experience at the station, and wherein applying is performed prior to occurrence of the event.
